(19) United States
(12) Patent Application Publication
(10) Pub. No.: US 2024/0369351 A1
(43) Pub. Date: Nov. 7, 2024

(54) METHOD AND APPARATUS FOR MEASUREMENT

(71) Applicant: Telefonaktiebolaget LM Ericsson (publ), Stockholm (SE)

(72) Inventors: Xiaohui WANG, Guangzhou (CN); Yinjie ZHENG, Guangzhou (CN); Guansheng LIANG, Guangzhou (CN); Qian SUN, Guangzhou (CN); Zhijin ZHANG, Guangzhou (CN); Ke XIAO, Guangzhou (CN); Fusheng HE, Guangzhou (CN); Hui WENG, Nanjing (CN); Xing LIU, Nanjing (CN); Caijun HANG, Nanjing (CN); Shanshan WANG, Nanjing (CN)

(21) Appl. No.: 18/688,548

(22) PCT Filed: Sep. 2, 2021
(86) PCT No.: PCT/CN2021/116262

§ 371 Date: Mar. 1, 2024

(51) Int. Cl. G01B 11/14; G01B 11/02; G01B 21/04; G06T 7/11

(52) U.S. Cl. CPC G01B 11/14; G01B 11/022; G01B 21/042; G06T 7/11; G06T 2207/20084; G06T 2207/30204

(57) ABSTRACT

Various embodiments of the present disclosure provide a method for measurement. The method includes: measuring a pixel-level size of one or more markers in a first image by applying image segmentation to the one or more markers in the first image. Each of the one or more markers may be designed in concentric circles way and have a predefined world-level size. In accordance with an embodiment, the method further includes: determining a mapping relationship between a pixel-level size and a world-level size, according to the measured pixel-level size and the predefined world-level size of the one or more markers.

### FIELD OF THE INVENTION

The present disclosure generally relates to image processing, and more specifically, to a method and apparatus for measurement.

### BACKGROUND

This section introduces aspects that may facilitate a better understanding of the disclosure. Accordingly, the statements of this section are to be read in this light and are not to be understood as admissions about what is in the prior art or what is not in the prior art.

In recent years, with the progress of computer technology and machine vision technology, size measurement develops from manual detection to machine detection. Currently, there are many computer-assisted devices that may greatly improve the size measurement, e.g., gap width measurement, etc. As an example, a device may be enhanced with the computer vision technology to extract the contour of a gap of an object in an image, acquire the gap width in pixels, and determine the gap width in the real world according to how many millimeters (mm) correspond to 1 pixel.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For the existing solutions of gap width measurement, the cost of manual detection may be very high because professional devices and workers may be needed. In addition, the manual detection may introduce an artificial measurement error, as it is easy to misread the measurement result. Although the computer vision technology may be applied for the gap width measurement, most solutions based on computer vision technology may have high failure rate of image calibration because an object such as a chessboard in an image may not be found, especially for the chessboard located in the complicated background. For the solutions based on computer vision technology, obtaining image calibration parameters may be a prerequisite for gap width measurement. Therefore, it may be desirable to implement the gap width measurement in a more efficient way.

Various embodiments of the present disclosure propose a solution for measurement, which can enable the size of an object in an image, e.g., gap width, etc. to be measured more accurately by using the computer vision technology.

It can be appreciated that the term “pixel-level size” described in this document may refer to the size of an object (e.g., a gap, a hole, a screw, etc.) measured at the pixel level or the image level. For example, the pixel-level width of a gap or the pixel-level distance between two points may be measured according to the pixel coordinates and represented in pixels.

Similarly, it can be appreciated that the term “world-level size” described in this document may refer to the actual physical size of an object (e.g., a gap, a hole, a screw, etc.) measured at the real-world level. For example, the world-level width of a gap or the world-level distance between two points may be measured according to the real-world physical coordinates and represented in metric units such as millimeter (mm).

It can be appreciated that the term “image segmentation” described in this document may refer to an image processing procedure that can be used to segment or extract a part of an original image. For example, the image segmentation may be applied to identify the contour of an object in an image, so as to segment or extract the object part from the image.

According to a first aspect of the present disclosure, there is provided a method for measurement which may be performed by an apparatus such as a server, a client device, etc. The method comprises: measuring a pixel-level size of one or more markers in a first image by applying image segmentation to the one or more markers in the first image. According to an embodiment, each of the one or more markers may be designed in concentric circles way and have a predefined world-level size. In accordance with an exemplary embodiment, the method further comprises: determining a mapping relationship between a pixel-level size and a world-level size, according to the measured pixel-level size and the predefined world-level size of the one or more markers.

In accordance with an exemplary embodiment, each of the one or more markers may include multiple concentric circles and each circle may have a predefined world-level size (e.g., radius, diameter, perimeter, etc.).

In accordance with an exemplary embodiment, the mapping relationship between the pixel-level size and the world-level size may be determined by: building up the mapping relationship between the pixel-level size and the world-level size, according to size measurements on one or more of the multiple concentric circles.

In accordance with an exemplary embodiment, the mapping relationship between the pixel-level size and the world-level size may be determined further by: verifying the mapping relationship between the pixel-level size and the world-level size and/or accuracy of image calibration, according to size measurements on remaining of the multiple concentric circles.

In accordance with an exemplary embodiment, the first image may be an image calibrated based at least in part on one or more distortion correction parameters. The one or more distortion correction parameters may be determined by performing a training process based on chessboard segmentation.

In accordance with an exemplary embodiment, the training process based on the chessboard segmentation may have chessboard images as input data and corresponding mask images as output data. The chessboard segmentation can extract chessboard parts from the chessboard images by using the corresponding mask images.

In accordance with an exemplary embodiment, the training process based on the chessboard segmentation may be performed by using a convolution neural network (e.g., a UNet model, etc.) or any other suitable artificial intelligence algorithms (e.g., deep learning algorithms).

In accordance with an exemplary embodiment, the one or more distortion correction parameters may be used to calibrate a second image (e.g., by using an image calibration model such as OpenCV, etc.) prior to applying image segmentation to an object in the second image.

In accordance with an exemplary embodiment, the method according to the first aspect of the present disclosure may further comprise: measuring a pixel-level size of an object in a second image by applying image segmentation to the object in the second image. The second image may be generated from a third image which includes the object and has a smaller size than the second image.

In accordance with an exemplary embodiment, the method according to the first aspect of the present disclosure may further comprise: determining a world-level size of the object, according to the measured pixel-level size of the object and the mapping relationship between the pixel-level size and the world-level size.

In accordance with an exemplary embodiment, the third image may be cropped from a fourth image which has a same size with the second image. The position of the third image in the second image may be same as the position of the third image in the fourth image. For example, the third image may be a region of interest (ROI) portion from the fourth image, and the fourth image may be the original image captured by a camera. In an embodiment, only the ROI portion from the original image may be transmitted to a server to generate the image to be measured, so as to save the amount of data transmission.

In accordance with an exemplary embodiment, the third image may have the image quality meeting a predetermined criterion. According to an embodiment, the image quality of the third image may be equal to or higher than a predefined quality level. Alternatively or additionally, the image quality score of the third image may be equal to or less than a predefined score.

In accordance with an exemplary embodiment, the image segmentation applied to the object in the second image may be implemented in a segmentation model (e.g., a UNet model, etc.). According to an embodiment, the segmentation model may be trained by using data augmentation with distortion parameter setting.

In accordance with an exemplary embodiment, the pixel-level size of the object in the second image may be measured by: determining one or more boundaries of the object in the second image, according to a result of the image segmentation. In an embodiment, the one or more boundaries may be indicated by subpixel coordinates of a set of segment points.

In accordance with an exemplary embodiment, the one or more boundaries may include a first boundary and a second boundary. The set of segment points may include one or more segment points on the first boundary and one or more corresponding segment points on the second boundary.

In accordance with an exemplary embodiment, the pixel-level size of the object in the second image may be represented by one or more distance values. Each of the one or more distance values may indicate a distance between a segment point on the first boundary and a corresponding segment point on the second boundary.

In accordance with an exemplary embodiment, the method according to the first aspect of the present disclosure may further comprise: triggering an alarm in response to one or more of the following events:
an average value of the one or more distance values is equal to or larger than a first threshold;
a difference between the largest distance value and the smallest distance value among the one or more distance values is equal to or larger than a second threshold;
an average value of the one or more distance values is equal to or less than a third threshold; and
a difference between the largest distance value and the smallest distance value among the one or more distance values is equal to or less than a fourth threshold.

It can be appreciated that the first, second, third and fourth thresholds mentioned above may be predefined as the same value or different values, depending on various application requirements.

According to a second aspect of the present disclosure, there is provided an apparatus which may be implemented as a server or a client device, etc. The apparatus may comprise one or more processors and one or more memories comprising computer program codes. The one or more memories and the computer program codes may be configured to, with the one or more processors, cause the apparatus at least to measure a pixel-level size of one or more markers in a first image by applying image segmentation to the one or more markers in the first image. In an embodiment, each of the one or more markers may be designed in concentric circles way and have a predefined world-level size. According to some exemplary embodiments, the one or more memories and the computer program codes may be configured to, with the one or more processors, cause the apparatus at least further to determine a mapping relationship between a pixel-level size and a world-level size, according to the measured pixel-level size and the predefined world-level size of the one or more markers.

In accordance with some exemplary embodiments, the one or more memories and the computer program codes may be configured to, with the one or more processors, cause the apparatus according to the second aspect of the present disclosure at least to perform any step of the method according to the first aspect of the present disclosure.

According to a third aspect of the present disclosure, there is provided a computer-readable medium storing computer program codes which, when executed on a computer, cause the computer to perform any step of the method according to the first aspect of the present disclosure.

Various exemplary embodiments according to the present disclosure can enable size measurement (e.g., gap width measurement, etc.) to be implemented in an easier and more accurate way. The special design of a marker can make the mapping relationship between the pixel-level size and the world-level size determined by using the marker more precise and generalized. In addition, application of various exemplary embodiments can enhance measurement performance and resource efficiency, e.g., by processing only the ROI part of the image, and/or training the image segmentation/calibration model to improve robustness, etc.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating exemplary chessboard segmentation according to an embodiment of the present disclosure;

FIG. 1B is a diagram illustrating an exemplary contour annotation according to an embodiment of the present disclosure;

FIG. 1C is a diagram illustrating an exemplary mask image according to an embodiment of the present disclosure;

FIG. 1D is a diagram illustrating exemplary training pairs according to an embodiment of the present disclosure;

FIG. 2A is a diagram illustrating an exemplary marker according to an embodiment of the present disclosure;

FIG. 2B is a diagram illustrating a set of exemplary markers according to an embodiment of the present disclosure;

FIG. 2C is a diagram illustrating an exemplary image with the tested object and markers according to an embodiment of the present disclosure;

FIG. 2D is a diagram illustrating exemplary segmentation results for inner circles of different markers according to an embodiment of the present disclosure;

FIG. 2E is a diagram illustrating exemplary verification of measurement results by other circles according to an embodiment of the present disclosure;

FIG. 2F is a diagram illustrating exemplary generation of anomalies according to an embodiment of the present disclosure;

FIG. 3A is a diagram illustrating an exemplary ROI according to an embodiment of the present disclosure;

FIG. 3B is a diagram illustrating an exemplary check of image quality according to an embodiment of the present disclosure;

FIG. 3C is a diagram illustrating an exemplary image generated from a ROI part according to an embodiment of the present disclosure;

FIG. 3D is a diagram illustrating exemplary gap segmentation results according to an embodiment of the present disclosure;

FIG. 3E is a diagram illustrating exemplary upper and lower boundaries of a gap according to an embodiment of the present disclosure;

FIG. 3F is a diagram illustrating an exemplary subpixel representation according to an embodiment of the present disclosure;

FIGS. 4A-4B are diagrams illustrating exemplary use cases of measurement according to some embodiments of the present disclosure;

FIG. 5 is a flowchart illustrating a procedure of gap width measurement according to an embodiment of the present disclosure;

FIG. 6 is a flowchart illustrating a method according to an embodiment of the present disclosure; and

FIG. 7 is a block diagram illustrating an apparatus according to an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Size measurement plays an important role in the manufacturing process. Various on-the-spot investigations show that the size measurement such as gap width measurement may just rely on workers manually using vernier caliper or other tools for measurement. The cost of manual detection may be expensive, and it is easy to misread the measurement result, so the gap width may not be detected with high precision because of human eyes fatigue.

Many solutions using the machine vision technology may be applied to solve this issue. For example, a solution based on the computer vision technology may be descried as below:
i). Using a calibration board to rectify the distortion of an image;
ii). Using a standard object to calculate how many millimeter (mm) may correspond to 1 pixel;
iii). Using the computer vision technology to extract the contour of a gap of the tested object; and
iv). Using the corresponding relationship calculated in step ii) to acquire the size of the gap (e.g., the gap width) in the real world.

The existing solutions using the computer vision technology may have the following defects:
Most solutions may use OpenCV to implement calibration, but this open source is not robust to the complicated background and the failure rate is very high.
The size of an image captured by an industrial camera is very large and transmission of the image to the cloud side may be very slow.
The computer vision based solutions require a standard object to get the corresponding relationship between the pixel-level distance and world-level distance. But the standard object is also measured by tools, so the standard object does not necessarily mean “standard”.
In reality, the image quality may not be always good since the focal length of the camera may be changed accidentally or there may be other issues happening. But this scenario may not be considered by many solutions.
Most of the gap segmentation samples are normal. It fails to cover abnormal scenarios such as a scenario where the upper and lower boundaries are not horizontal.

In order to solve one or more of the above issues, various exemplary embodiments of the present disclosure propose a solution for gap width measurement by using the computer vision technology. The proposed solution can implement calibration in a more robust way, which can successfully conquer the issue that OpenCV fails to detect cross-corner points if the background of an image is complex. The proposed solution may be easily deployed and provide a simple way to process a ROI part of an image so as to save bandwidth resource. Instead of using a standard object, a marker with the pre-defined size may be utilized to calculate a mapping relationship between the pixel-level size and the world-level size. It may be easy to segment the marker from the image. In addition, the design of markers may be beneficial to mapping relationship calculation and testing. In an embodiment, for image data augmentation, more abnormal samples for gap width measurement may be obtained by distorting them with different coefficients. In another embodiment, an image quality evaluator such as Blind/Referenceless Image Spatial QUality Evaluator (BRISQUE) may be used to check the image quality and the samples with bad quality may be abandoned. Optionally, a subpixel scheme may be used to make the measurement result more precise.

It can be appreciated that although various embodiments in this present disclosure are described with respect to gap width measurement, the application area of the proposed solution may not limit to it, but may be applicable to any size measurement.

In accordance with exemplary embodiments, there is provided a solution for gap width measurement. The solution may be divided into two parts or phases, including Part I “calibration and training phase” and Part II “detection phase”. Part I aims at getting a mapping relationship between a pixel-level size and a world-level size and acquiring a gap segmentation model based on artificial intelligence (e.g., a deep learning algorithm, a convolution neural network, etc.). Part II aims at measuring the gap width of an object. As an example, the two parts may include the following steps:
Part I: Calibration and training phase.
Step 1: Rectify an image by calibration.
   a) Use an image segmentation model (e.g., a convolution network for biomedical image segmentation such as UNet, etc.) to segment a chessboard.
   b) Use an image calibration model (e.g., OpenCV application programming interface (API), etc.) to calculate a distortion related matrix.
Step 2: Obtain standard markers (which may be generated by using AutoCAD) and paste the markers onto an object to be tested.
Step 3: Use an image segmentation model (e.g., a convolution network for biomedical image segmentation such as UNet, etc.) to segment a marker and calculate the mapping relationship between a pixel-level size and a world-level size (e.g., between a pixel-level distance/width and a world-level distance/width, etc.). In an embodiment, the calculation operation in Step 3 of Part I may need to be implemented after the calibration operation in Step 1 of Part I, although this is not necessary in some embodiments.
Step 4: Collect gap samples. Most gap images are usually normal. Besides the conventional image augmentation, different distortion coefficients may be used to collect more anomalies from the gap images to make the result of image segmentation/calibration more robust.
Step 5: Train an image segmentation model (e.g., a convolution network for biomedical image segmentation such as UNet, etc.) for gap segmentation.
Part II: Detection phase.
Step 1: Transmit only a ROI part of an original image to a server or the cloud side so as to save bandwidth resource.
Step 2: Check the image quality. Raise an alarm if the image quality is equal to or lower than a threshold.
Step 3: Calibrate the image. The image calibration may be performed on an image generated with the ROI part and a specific background, e.g., a white background, etc.
Step 4: Segment a gap in the ROI part of the image to measure the gap width by using the image segmentation model (e.g., UNet, etc.) trained in Step 5 of Part I.
Step 5: Get the corresponding points of the gap. For example, a predetermined number (e.g., 5, etc.) of groups of points may be obtained, and each group has two points which may be respectively represented by the pixel/subpixel coordinates on two boundaries (e.g., upper boundary and lower boundary) of the gap.

The above steps in the two parts will be described in detail below in connection with the accompanying drawings.

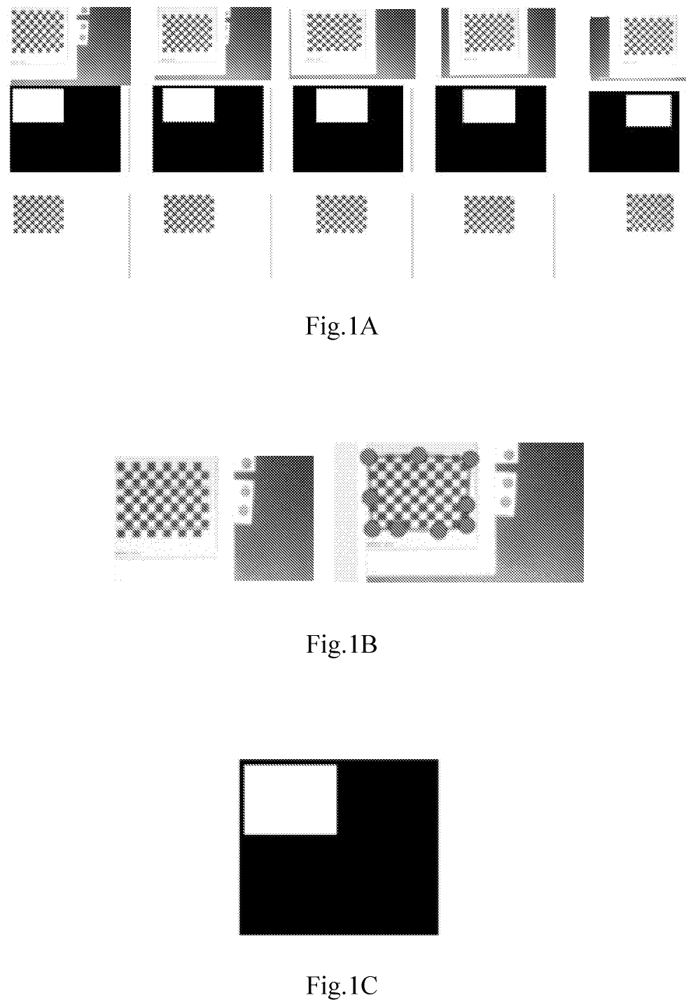

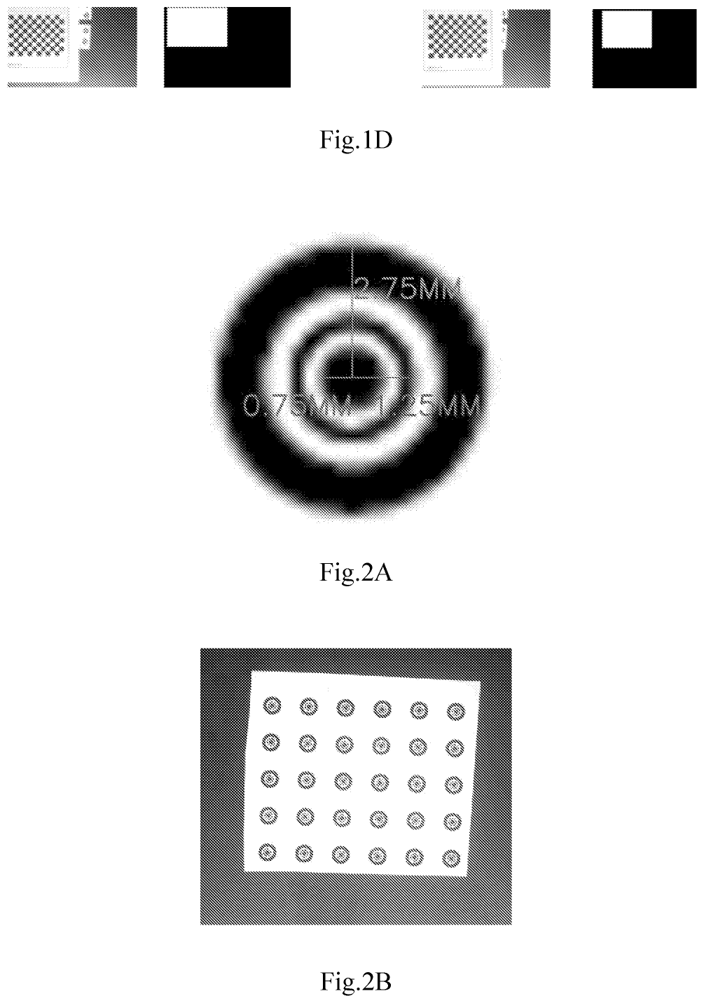

FIG. 1A is a diagram illustrating exemplary chessboard segmentation according to an embodiment of the present disclosure. In accordance with an exemplary embodiment, an image segmentation model such as UNet model may be used to segment a chessboard image. After segmentation of the chessboard image, only a chessboard part is kept and the background area of the chessboard image is turned to white. As shown in FIG. 1A, the first row of images corresponds to the original chessboard images; the second row of images corresponds to the mask images where the white area is used to segment a target object (i.e. the chessboard part) from the original image and the black area is used to mask the background of the original image; and the third row of images corresponds to the results of image segmentation, i.e., the chessboard parts of the original chessboard images.

FIG. 1B is a diagram illustrating an exemplary contour annotation according to an embodiment of the present disclosure. In order to implement the image segmentation, the contour of a target object to be segmented may need to be identified. As an example, for the original chessboard image on the left part of FIG. 1B, an application such as Labelme may be used to annotate the contour of the chessboard part in the original chessboard image. The right part of FIG. 1B shows the chessboard part annotated by Labelme.

FIG. 1C is a diagram illustrating an exemplary mask image according to an embodiment of the present disclosure. The mask image shown in FIG. 1C may be used to segment or extract the chessboard part from the original chessboard image shown in FIG. 1B. According to an exemplary embodiment, OpenCV API may be used to get the mask image in FIG. 1C, e.g., by polygon filling. It can be appreciated that the mask image also may be obtained by using other suitable applications or technologies in addition to OpenCV API.

In accordance with an exemplary embodiment, the UNet model for image segmentation may be trained until it converges. The training process may be implemented, e.g., by repeatedly collecting samples for chessboard segmentation, including the original chessboard images as shown in FIG. 1B and the mask images as shown in FIG. 1C.

FIG. 1D is a diagram illustrating exemplary training pairs according to an embodiment of the present disclosure. The training pairs include training input data and training output data. As an example, for the UNet model, the training pair for input and output may consist of the original image to be segmented and its corresponding mask image. For each of the training pairs in FIG. 1D, the original chessboard image is the training input data, while the mask image is the training label or training output data.

In the calibration and training phase of Part I, as described with respect to Step 1 of Part I, the chessboard segmentation may be added before image calibration which may be implemented by applying OpenCV API, so that the failure rate of image calibration by OpenCV can be dramatically reduced. As described with respect to FIG. 1A-1D, the image segmentation may be applied to trace the object part, determine its contour, and get the mask image by only keeping the object part and turning the background to white. The masked image may be provided to an image calibration model such as OpenCV API to implement different post-processing such as calibration. In accordance with an exemplary embodiment, the image calibration model may be used to calculate distortion correction parameters, e.g., a distortion related matrix, etc. The distortion correction parameters may be used to rectify an image by calibration.

In accordance with an exemplary embodiment, one or more standard markers may be designed to determine a mapping relationship between a pixel-level size and a world-level size. The design of a marker may need to meet one or more requirements as below:
The shape of the marker can cause the marker to be easily segmented.
The parameter(s) related to the pixel-level size (e.g., width, distance, etc.) can be easily acquired.
The world-level size of the marker can be pre-defined very precisely. For example, the marker may have a shape generated or determined by using a graphics application such as AutoCAD.
The marker can be easily fastened on the tested object.
The marker can be used to verify the mapping relationship between the pixel-level size and the world-level size, so as to generalize the mapping relationship as a measurement rule.

In accordance with an exemplary embodiment, the marker may be designed in concentric circles way. A circle may be a good choice for the marker because it may be very easy to segment a circle and the radius/diameter/perimeter of the circle can be determined precisely, e.g., by using OpenCV API with cv2.findContours and cv2.minClosingCircle through the mask image.

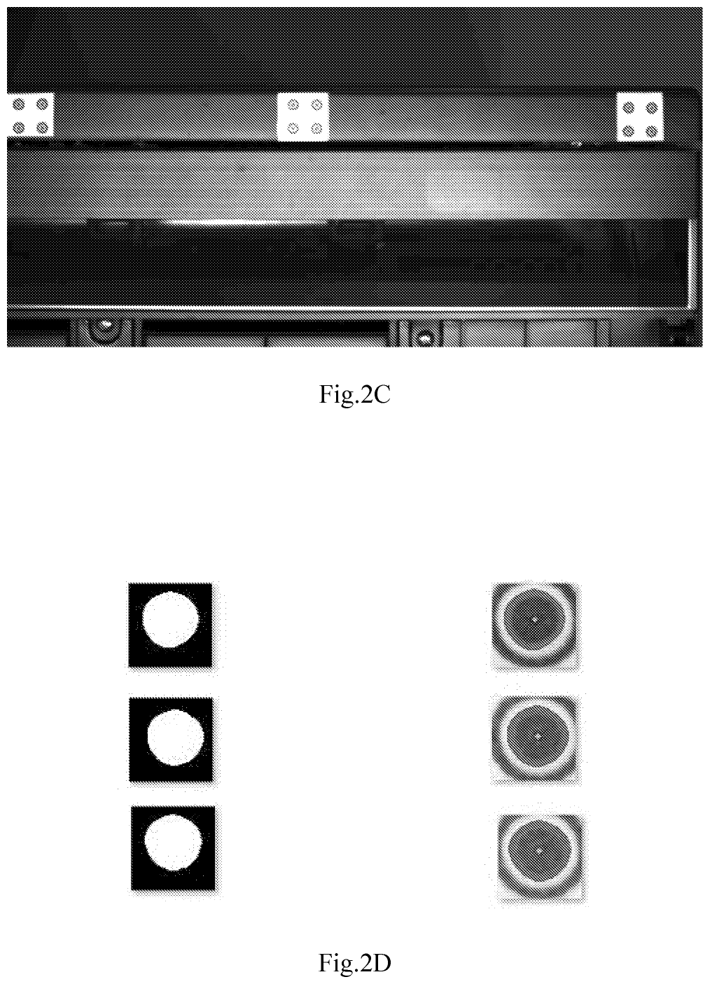

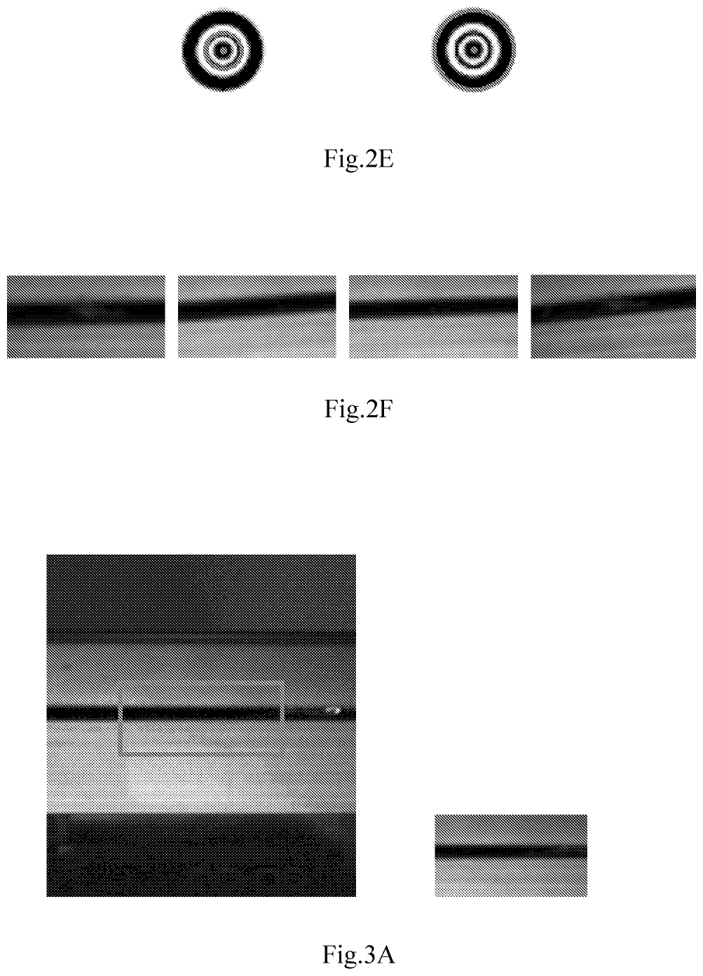

FIG. 2A is a diagram illustrating an exemplary marker according to an embodiment of the present disclosure. As shown in FIG. 2A, the exemplary marker is designed to have three circles, and the radiuses from inner to outer are 0.75 mm, 1.25 mm, 2.75 mm, respectively. It can be appreciated that the marker may have more or less circles and the radius values may include other suitable pre-defined values. In an embodiment, the circle radius may be designed such that the gap width of the tested object is between the radius values of the middle circle and the outer circle. For example, if the gap width is about 2 mm, the radius value(s) of the circle(s) may be pre-defined as shown in FIG. 2A according to the gap width.

In accordance with an exemplary embodiment, the inner circle of the marker may be utilized to build up the mapping relationship between a pixel-level size and a world-level size. In some embodiments, other circles may be utilized to verify whether the measurement rule (i.e., the mapping relationship between the pixel-level and world-level sizes) can be generalized or not. This may be facilitated by designing the marker so that the gap width is between the radiuses of the middle circle and the outer circle.

FIG. 2B is a diagram illustrating a set of exemplary markers according to an embodiment of the present disclosure. As shown in FIG. 2B, the markers may be generated by a graphics application such as AutoCAD and printed on a piece of paper. The size of a marker may be pre-defined according to the size of the tested object and/or other specific requirements. It can be appreciated that the number, shape, size and arrangement of the markers shown in FIG. 2B are just examples, and other suitable numbers, shapes, sizes and arrangements of the markers may be applied according to different application scenarios and service requirements.

FIG. 2C is a diagram illustrating an exemplary image with the tested object and markers according to an embodiment of the present disclosure. As shown in FIG. 2C, three parts each containing four markers are cropped from the paper printed with markers and pasted onto the tested object. It can be appreciated that although three cropped parts each containing four markers are used in the embodiment of FIG. 2C, more or less cropped parts with each part containing more or less markers may be applicable for size measurement on the tested object. In an embodiment, one or more images containing the tested object and the pasted markers may be captured, and the pixel-level size of one or more circles in the marker(s) can be measured by applying image calibration and segmentation on the image.

FIG. 2D is a diagram illustrating exemplary segmentation results for inner circles of different markers according to an embodiment of the present disclosure. An image segmentation model such as UNet may be used to segment or extract a marker portion, e.g., from the image shown in FIG. 2C. Through segmenting the marker by UNet, the centroid and radius of the marker can be acquired by OpenCV API, after getting the mask image. In FIG. 2D, the mask images used to extract the inner circle images of three markers are illustrated in the left column, and the extracted inner circle images containing the contour and centroid are illustrated in the right column.

In accordance with an exemplary embodiment, 12 markers are pasted onto the tested object (e.g., as shown in FIG. 2C). The pixel-level measurement may be performed to get the respective radius results of inner circles of these 12 markers. In an embodiment, the radius results may be averaged for the pixel-level measurement, so as to achieve the mapping relationship between the pixel-level size and the world-level size. For example, if the average pixel-level radius is 24 pixels and the pre-defined world-level radius of the inner circle is 0.75 mm, then each pixel equals 0.75 mm/24 pixel=0.03125 mm/pixel. In this case, if the pixel-level width of the object is 108 pixels, then the world-level width of the object is 0.03125*108=3.375 mm. In another embodiment, this mapping relationship between the pixel-level size and the world-level size may be verified by the measurement results of other circles (e.g., the middle circles and/or the outer circles) of the markers.

FIG. 2E is a diagram illustrating exemplary verification of measurement results by other circles according to an embodiment of the present disclosure. As shown in FIG. 2E, the image segmentation model such as UNet may be used to extract other concentric circle images of the markers. The pixel-level measurement may be performed to get the respective radius results of the other concentric circles, e.g., including the middle circles and/or the outer circles. According to the radius results of the other concentric circles, the mapping relationship between the pixel-level size and the world-level size can be calculated in a manner similar to that described in connection with FIG. 2D. If the calculated mapping relationship meets the expectation, e.g., a difference between different calculation results of mapping relationship equal to or less than a certain threshold, it may be considered that the generalization of mapping relationship is successfully verified. Otherwise, the mapping relationship may need to be recalculated, and/or the image calibration may need to be adjusted.

In accordance with an exemplary embodiment, besides the traditional image augmentation schemes, some data augmentation including anomalies may be introduced to improve performance of image segmentation and image calibration for the object such as a gap to be tested.

FIG. 2F is a diagram illustrating exemplary generation of anomalies according to an embodiment of the present disclosure. In a conventional image processing procedure, it may be required to get rid of image distortion. However, tactfully utilizing different distortion settings to generate anomalies may be able to make the image processing performance more robust to different scenarios. For example, different distortion coefficients may be used to collect more anomalies to make the image segmentation/calibration results more robust. As shown in FIG. 2F, four gap images may be generated according to different distortion coefficients. The edges of these gaps are not horizontal and some are slightly bent. These gap images may be used as input for training the image segmentation model such as UNet. As such, the trained image segmentation model can handle diversified gap images and provide better segmentation performance.

When the mapping relationship between the pixel-level size and the world-level size is determined and optionally the image segmentation model such as UNet is trained during the calibration and training phase in Part I, the size of a target object such as gap width may be detected and measured. During the detection phase in Part II, there may be no need to paste markers on the object to be detected. In some application scenarios, the size of an image captured by an industrial camera may be very large. For example, the size of the captured image with 2448*2048 resolution may reach to 14.3 M. In order to improve transmission efficiency dramatically, a portion of the originally captured image, i.e. a ROI of the image, may be cropped and only this portion of the image may be transmitted to a server at which the size of the detected object may be measured by applying the computer vision technology on the ROI of the image.

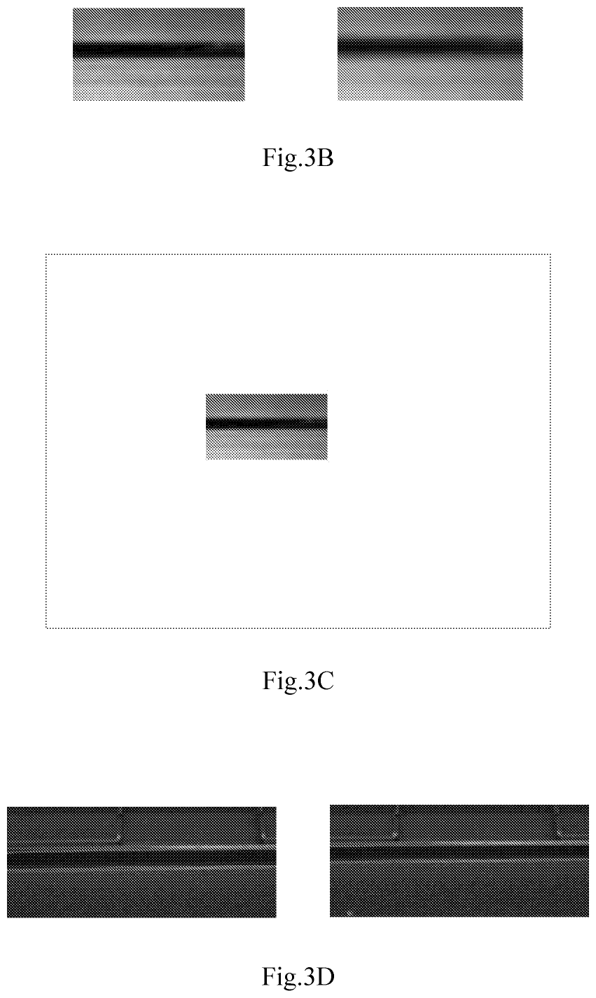

FIG. 3A is a diagram illustrating an exemplary ROI according to an embodiment of the present disclosure. As shown in FIG. 3A, the image on the left is the original image where the portion framed by a box is a ROI part, and the image on the right only includes the ROI part. In an embodiment, the ROI may be pre-defined by configuring the camera setting. An object to be measured such as a gap shown in FIG. 3A is included in the ROI part of the image. As mentioned previously, only the ROI part of the image may be transmitted, e.g., via a communication network such as fourth generation (4G)/long term evolution (LTE) and fifth generation (5G)/new radio (NR) networks, to a server to measure the size of the object. Since the size of the ROI is less than the size of the original image, the amount of transmitted image data may be decreased significantly.

In reality, the image quality may not be always good since the focal length of the camera may be changed accidentally or as other issues happen. So the image quality may need to be checked before further handling. For example, one or more image samples (e.g., the original images or only ROI parts of the original images) may be checked so as to identify the image sample(s) with satisfied image quality. In an embodiment, only the identified image sample(s) can be provided to the server for size measurement.

FIG. 3B is a diagram illustrating an exemplary check of image quality according to an embodiment of the present disclosure. In FIG. 3B, the quality of the image on the left is better than that of the image on the right. Various image quality assessment approaches, e.g., BRISQUE, etc. may be applied for checking the image quality. In an embodiment using BRISQUE, it may calculate a mean subtracted contrast normalized (MSCN) coefficient and finally uses a support vector machine (SVM) regressor. With the image quality assessment by BRISQUE, the image on the left in FIG. 3B may have a clear image score such as 60.3, and the image on the right in FIG. 3B may have a blur image score such as 81.6. The higher score means the lower quality. According to an embodiment, an alarm may be raised if the image score of a sample is higher than a threshold, and then this sample may be dropped.

FIG. 3C is a diagram illustrating an exemplary image generated from a ROI part according to an embodiment of the present disclosure. The image shown in FIG. 3C may be generated based on a background image such as a pure white image in a memory of the server. The size of the background image may be equal to the original image from which the ROI part is cropped. For example, the image in FIG. 3C may be generated by putting the ROI part to a position on the background image which is the same as its place on the original image. In an embodiment, image calibration may be performed for the generated image, e.g., according to one or more distortion correction parameters acquired by Step 1 of Part I.

FIG. 3D is a diagram illustrating exemplary gap segmentation results according to an embodiment of the present disclosure. An image segmentation model (e.g., the UNet model trained as described with respect to FIG. 2F, etc.) may be used to detect a gap as shown in each image of FIG. 3D. For example, the contour tracking function of the image segmentation model may be used to extract the upper and lower boundaries of the gap. It can be appreciated that although the direction of the gap shown in FIG. 3D is horizontal, the direction of the gap also may be vertical or any other possible directions. Thus, the gap segmentation results may indicate the left and right boundaries of the gap, the inner and outer boundaries of the gap, and/or any other possible parameters reflecting the gap width, etc. In accordance with an exemplary embodiment, one or more segment points on one boundary of the gap and the corresponding segment points on the other boundary of the gap may be identified as required.

FIG. 3E is a diagram illustrating exemplary upper and lower boundaries of a gap according to an embodiment of the present disclosure. As shown in FIG. 3E, five groups of segment points on the upper and lower boundaries of the gap are identified and used to divide the upper/lower boundary into six parts. For example, each segment point on the lower/upper boundary may be identified by the closest pixel coordinate in x-axis. In an embodiment, a subpixel representation may be used to refine the pixel coordinate.

FIG. 3F is a diagram illustrating an exemplary subpixel representation according to an embodiment of the present disclosure. A zoom-in image of one boundary (e.g., the upper boundary shown in FIG. 3E) of a gap is shown in FIG. 3F. In the case that the subpixel representation is adopted, the coordinate of the boundary may be represented in more precise manner. For instance, for the pixel coordinate (120, 220), if the subpixel representation is applied, the corresponding subpixel coordinate may be (120.25, 220.50). The float point value of the subpixel coordinate may be acquired so that the measurement result is more accurate. It can be appreciated that in addition to the subpixel representation scheme, other suitable schemes also may be used to get the precise contour and make the measurement result more accurate.

In accordance with an exemplary embodiment, the distance between one segment point and its corresponding segment point in each group of segment points may be used to indicate a gap width. For example, five Euclidean distance values can be calculated for the five groups of segment points shown in FIG. 3E. In an embodiment, an alarm may be raised if at least one of the following conditions is met:
The average distance value exceeds a threshold or within a specific range; and
The difference between the largest distance value and the smallest one exceeds another threshold or within another specific range.

It can be appreciated that in addition to the gap width measurement, various embodiments according to the present disclosure also may be applicable to other use cases of measurement.

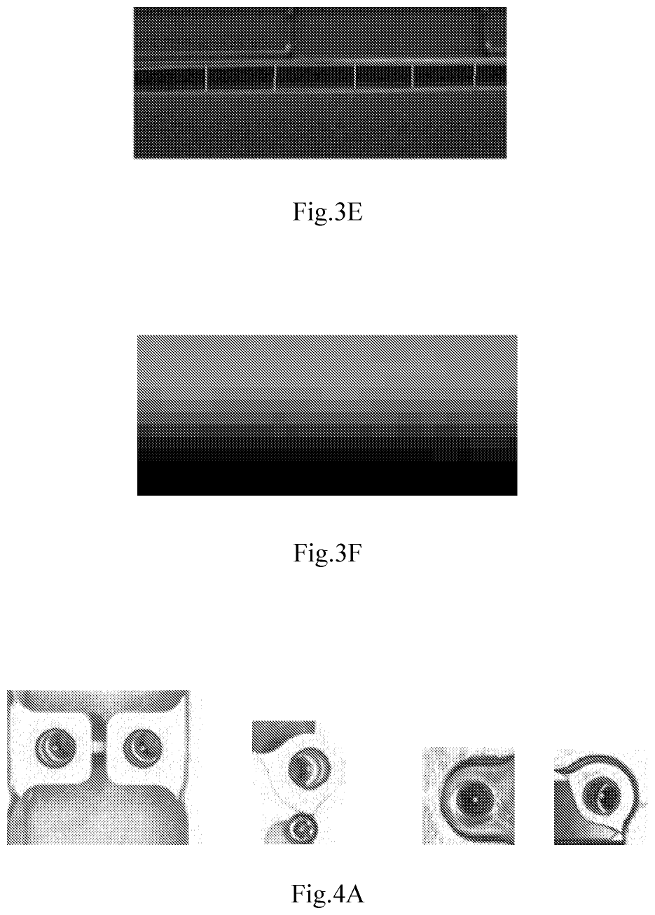

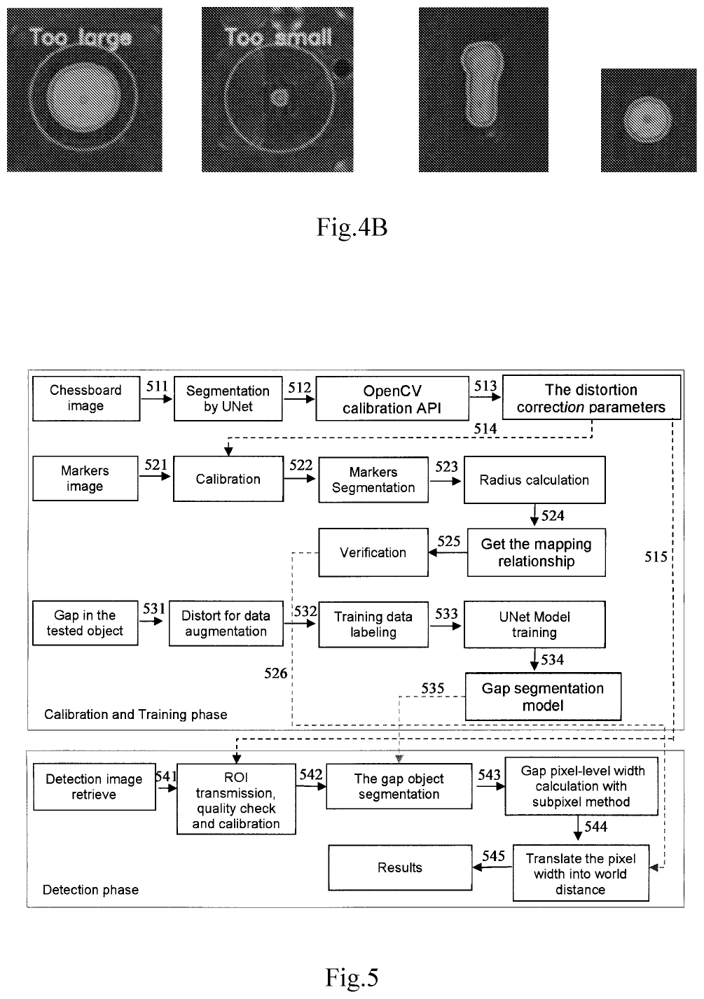

FIGS. 4A-4B are diagrams illustrating exemplary use cases of measurement according to some embodiments of the present disclosure. FIG. 4A shows screw hole size measurement according to an exemplary embodiment, and FIG. 4B shows putty shape measurement according to another exemplary embodiment. The measurement results may be used to determine whether the size and/or shape of an object meets the requirement, e.g., whether the size of the object is too large or too small.

FIG. 5 is a flowchart illustrating an exemplary procedure of gap width measurement according to an embodiment of the present disclosure. The procedure may be performed by using the computer vision technology. As shown in FIG. 5, the procedure may include the calibration and training phase and the detection phase. In the calibration and training phase, a chessboard image may be provided 511 to an image segmentation model such as UNet to get a chessboard image segmentation result. In an embodiment, the chessboard image segmentation result may be sent 512 to an OpenCV calibration API to get 513 one or more distortion correction parameters. In order to determine a mapping relationship between a pixel-level size and a world-level size, an image containing one or more markers may be sent 521 to an image calibration model such as OpenCV and calibrated according to the one or more distortion correction parameters 514. In an embodiment, a portion containing one or more markers may be cropped from the calibrated image and provided 522 to an image segmentation model such as UNet to implement marker segmentation. The marker extracted from the cropped image portion by the image segmentation model may be used to calculate 523 the pixel-level radius value of a circle in the marker, e.g. by using UNet and OpenCV API. The calculated pixel-level radius value of the circle may be used, together with the pre-defined world-level radius value of the circle, to get 524 the mapping relationship between the pixel-level size and the world-level size. Optionally, the mapping relationship between the pixel-level size and the world-level size may be verified 525 so as to implement generalization of the mapping relationship. In an embodiment, one or more samples each reflecting a gap in the tested object may be collected to generate 531 one or more distortion coefficients for data augmentation. By using various distortion schemes for data augmentation, the one or more distortion coefficients may be used 532 for training data labeling, so as to implement 533 UNet model training. The trained UNet model may be used 534 as a gap segmentation model.

In the detection phase, an image containing an object with a gap to be detected may be captured or retrieved by a camera. The ROI part of the image may be transmitted 541 to a server for gap measurement. In an embodiment, the image quality of the ROI part may be checked prior to implementing image calibration, which is realized by applying distortion correction parameters, 515, on an image generated based on the ROI part. After calibration, the image generated based on the ROI part may be provided 542 to a gap segmentation model such as the trained UNet model to implement gap segmentation on the object. By using 535 the gap segmentation model, one or more boundaries of the gap and/or a set of segment points on the boundaries may be identified. The pixel-level gap width may be calculated 543 according to the pixel/subpixel coordinates of several segment points on the boundaries. According to an embodiment, the subpixel representation may be used to improve accuracy of the measured gap width. According to the mapping relationship between the pixel-level size and the world-level size 526, the pixel-level gap width can be translated 544 into the world-level gap width which may be output 545 as the measurement result of gap width.

Many advantages can be achieved by applying the proposed solution according to various exemplary embodiments. For example, since the marker is designed elaborately, a mapping relationship between a pixel-level size and a world-level size can be determined more accurately. In addition, the transmission efficiency may be improved dramatically due to the calibration/segmentation on only a ROI part of an image. It may be easy and simple to deploy such ROI calibration/segmentation. Moreover, the proposed solution according to various exemplary embodiments can greatly increase success rate of image calibration even if the image background is complicated. For the image segmentation, a special image data augmentation scheme may be used to generate more anomalies for image segmentation, so as to make the size measurement become more robust. According to an exemplary embodiment, some image samples with low quality may be dropped to make the measurement result more reliable. Optionally, the subpixel scheme may be used to perfect the measurement result. In an embodiment, a deep learning algorithm may be applied to make the proposed solution more robust to a light environment change. It can be appreciated that the proposed solution may be scalable to other use cases for size automatic measurement.

It can be appreciated that the UNet model and OpenCV API as described above are just examples, and according to different application requirements, various models and algorithms such as deep learning algorithms, convolution neural networks, and image processing technologies for segmentation and calibration may be applicable for various exemplary embodiments according to the present disclosure.

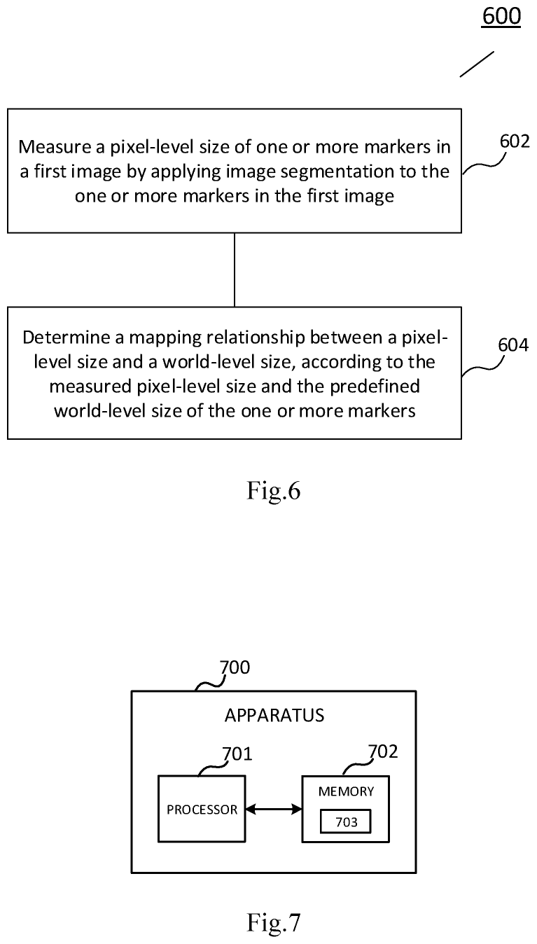

FIG. 6 is a flowchart illustrating a method 600 according to an embodiment of the present disclosure. The method 600 illustrated in FIG. 6 may be performed by an apparatus which may be able to utilize the computer vision technology or be communicatively coupled to an image processor. In accordance with an exemplary embodiment, the apparatus may comprise a server, a client device or any other suitable device which is capable of implementing size measurement by using the computer vision technology.

According to the exemplary method 600 illustrated in FIG. 6, the apparatus can measure a pixel-level size of one or more markers in a first image (e.g., the image shown in FIG. 2C) by applying image segmentation to the one or more markers in the first image, as shown in block 602. In accordance with an exemplary embodiment, each of the one or more markers may be designed in concentric circles way and have a predefined world-level size. According to the measured pixel-level size and the predefined world-level size of the one or more markers, the apparatus can determine a mapping relationship between a pixel-level size and a world-level size, as shown in block 604.

In accordance with an exemplary embodiment, each of the one or more markers may include multiple concentric circles (as shown in FIG. 2A, FIG. 2B and FIG. 2C) and each circle may have a predefined world-level size (e.g., radius, diameter, perimeter, etc.).

In accordance with an exemplary embodiment, the apparatus can determine the mapping relationship between the pixel-level size and the world-level size by building up the mapping relationship between the pixel-level size and the world-level size, according to size measurements on one or more of the multiple concentric circles.

In accordance with an exemplary embodiment, the apparatus can determine the mapping relationship between the pixel-level size and the world-level size further by verifying the mapping relationship between the pixel-level size and the world-level size and/or accuracy of image calibration, according to size measurements on remaining of the multiple concentric circles. In some cases, if the mapping relationships determined according to the size measurements on different concentric circles are inconsistent, the mapping relationship built up previously may need to be modified, and/or the current image calibration may be inaccurate and require adjustment.

In accordance with an exemplary embodiment, the first image may be an image calibrated based at least in part on one or more distortion correction parameters. The one or more distortion correction parameters may be determined by performing a training process based on chessboard segmentation (e.g., as described with respect to FIGS. 1A-1D and FIG. 5).

In accordance with an exemplary embodiment, the training process based on the chessboard segmentation may have chessboard images as input data and corresponding mask images as output data. The chessboard segmentation can extract chessboard parts from the chessboard images by using the corresponding mask images.

In accordance with an exemplary embodiment, the training process based on the chessboard segmentation may be performed by using a convolution neural network (e.g., a UNet model, etc.) or any other suitable artificial intelligence algorithms (e.g., deep learning algorithms, etc.).

In accordance with an exemplary embodiment, the one or more distortion correction parameters may be used to calibrate a second image (e.g., by using an image calibration model such as OpenCV, etc.) prior to applying image segmentation to an object (e.g., a gap, etc.) in the second image.

In accordance with an exemplary embodiment, the apparatus can measure a pixel-level size of an object (e.g., a gap, etc.) in a second image (e.g., the image shown in FIG. 3C) by applying image segmentation to the object in the second image (e.g., as described with respect to FIGS. 3C-3E). The second image may be generated from a third image (e.g., the right image shown in FIG. 3A) which includes the object and has a smaller size than the second image.

In accordance with an exemplary embodiment, the apparatus can determine a world-level size of the object, according to the measured pixel-level size of the object and the mapping relationship between the pixel-level size and the world-level size.

In accordance with an exemplary embodiment, the third image may be cropped from a fourth image (e.g., the left image shown in FIG. 3A) which has a same size with the second image. The position of the third image in the second image may be same as the position of the third image in the fourth image. For example, the third image may be a ROI portion from the fourth image, and the fourth image may be the original image captured by a camera.

In accordance with an exemplary embodiment, the third image may have an image quality which meets a predetermined criterion. According to an embodiment, the image quality of the third image may be equal to or higher than a predefined quality level. Alternatively or additionally, the image quality score of the third image may be equal to or less than a predefined score.

In accordance with an exemplary embodiment, the image segmentation applied to the object in the second image may be implemented in a segmentation model (e.g., a UNet model, etc.). According to an embodiment, the segmentation model may be trained by using data augmentation with distortion parameter setting (e.g., as described with respect to FIG. 2F).

In accordance with an exemplary embodiment, the apparatus can measure the pixel-level size of the object in the second image by determining one or more boundaries of the object in the second image, according to a result of the image segmentation. In an embodiment, the one or more boundaries may be indicated by subpixel coordinates of a set of segment points.

In accordance with an exemplary embodiment, the one or more boundaries may include a first boundary and a second boundary. The set of segment points may include one or more segment points on the first boundary and one or more corresponding segment points on the second boundary (e.g., as described with respect to FIG. 3E).

In accordance with an exemplary embodiment, the pixel-level size of the object in the second image may be represented by one or more distance values. Each of the one or more distance values may indicate a distance between a segment point on the first boundary and a corresponding segment point on the second boundary.

In accordance with an exemplary embodiment, the apparatus may trigger an alarm in response to one or more of the following events:
an average value of the one or more distance values is equal to or larger than a first threshold;
a difference between the largest distance value and the smallest distance value among the one or more distance values is equal to or larger than a second threshold;
an average value of the one or more distance values is equal to or less than a third threshold; and
a difference between the largest distance value and the smallest distance value among the one or more distance values is equal to or less than a fourth threshold.

It can be appreciated that the first, second, third and fourth thresholds mentioned above may be predefined as the same value or different values, depending on various application requirements.

The various blocks shown in FIGS. 5-6 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 7 is a block diagram illustrating an apparatus 700 according to various embodiments of the present disclosure. As shown in FIG. 7, the apparatus 700 may comprise one or more processors such as processor 701 and one or more memories such as memory 702 storing computer program codes 703. The memory 702 may be non-transitory machine/processor/computer readable storage medium. In accordance with some exemplary embodiments, the apparatus 700 may be implemented as an integrated circuit chip or module that can be plugged or installed into a server or a client device such that the server or the client device may be able to implement the method as described with respect to FIG. 6.

In some implementations, the one or more memories 702 and the computer program codes 703 may be configured to, with the one or more processors 701, cause the apparatus 700 at least to perform any operation of the method as described in connection with FIG. 6. Alternatively or additionally, the one or more memories 702 and the computer program codes 703 may be configured to, with the one or more processors 701, cause the apparatus 700 at least to perform more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

What is claimed is:

1. A method for measurement, comprising:
measuring a pixel-level size of one or more markers in a first image by applying image segmentation to the one or more markers in the first image, wherein each of the one or more markers is designed in concentric circles way and has a predefined world-level size; and
determining a mapping relationship between a pixel-level size and a world-level size, according to the measured pixel-level size and the predefined world-level size of the one or more markers.

2. The method according to claim 1, wherein each of the one or more markers includes multiple concentric circles and each circle has a predefined world-level size.

3. The method according to claim 2, wherein the mapping relationship between the pixel-level size and the world-level size is determined by:
building up the mapping relationship between the pixel-level size and the world-level size, according to size measurements on one or more of the multiple concentric circles; and
verifying the mapping relationship between the pixel-level size and the world-level size and/or accuracy of image calibration, according to size measurements on remaining of the multiple concentric circles.

4. The method according to claim 1, wherein the first image is an image calibrated based at least in part on one or more distortion correction parameters, and wherein the one or more distortion correction parameters are determined by performing a training process based on chessboard segmentation.

5. The method according to claim 4, wherein the training process based on the chessboard segmentation has chessboard images as input data and corresponding mask images as output data, and wherein the chessboard segmentation extracts chessboard parts from the chessboard images by using the corresponding mask images.

6. The method according to claim 4, wherein the training process based on the chessboard segmentation is performed by using a convolution neural network.

7. The method according to claim 4, wherein the one or more distortion correction parameters are used to calibrate a second image prior to applying image segmentation to an object in the second image.

8. The method according to claim 1, further comprising:
measuring a pixel-level size of an object in a second image by applying image segmentation to the object in the second image, wherein the second image is generated from a third image which includes the object and has a smaller size than the second image; and
determining a world-level size of the object, according to the measured pixel-level size of the object and the mapping relationship between the pixel-level size and the world-level size.

9. The method according to claim 8, wherein the third image is cropped from a fourth image which has a same size with the second image, and a position of the third image in the second image is same as a position of the third image in the fourth image.

10. The method according to claim 8, wherein the third image has an image quality which meets a predetermined criterion.

11. The method according to claim 8, wherein the image segmentation applied to the object in the second image is implemented in a segmentation model which is trained by using data augmentation with distortion parameter setting.

12. The method according to claim 8, wherein the pixel-level size of the object in the second image is measured by:
determining one or more boundaries of the object in the second image, according to a result of the image segmentation, wherein the one or more boundaries are indicated by subpixel coordinates of a set of segment points.

13. The method according to claim 12, wherein the one or more boundaries include a first boundary and a second boundary, and wherein the set of segment points include one or more segment points on the first boundary and one or more corresponding segment points on the second boundary.

14. The method according to claim 13, wherein the pixel-level size of the object in the second image is represented by one or more distance values, and each of the one or more distance values indicates a distance between a segment point on the first boundary and a corresponding segment point on the second boundary.

15. The method according to claim 14, further comprising triggering an alarm in response to one or more of the following events:
an average value of the one or more distance values is equal to or larger than a first threshold;
a difference between the largest distance value and the smallest distance value among the one or more distance values is equal to or larger than a second threshold;
an average value of the one or more distance values is equal to or less than a third threshold; and
a difference between the largest distance value and the smallest distance value among the one or more distance values is equal to or less than a fourth threshold.

16. An apparatus for measurement, comprising:
one or more processors; and
one or more memories storing computer program codes,
the one or more memories and the computer program codes configured to, with the one or more processors, cause the apparatus at least to:
measure a pixel-level size of one or more markers in a first image by applying image segmentation to the one or more markers in the first image, wherein each of the one or more markers is designed in concentric circles way and has a predefined world-level size; and
determine a mapping relationship between a pixel-level size and a world-level size, according to the measured pixel-level size and the predefined world-level size of the one or more markers.

17. The apparatus according to claim 16, wherein each of the one or more markers includes multiple concentric circles and each circle has a predefined world-level size.

18. (canceled)

19. The apparatus according to claim 17, wherein the mapping relationship between the pixel-level size and the world-level size is determined by:
building up the mapping relationship between the pixel-level size and the world-level size, according to size measurements on one or more of the multiple concentric circles; and
verifying the mapping relationship between the pixel-level size and the world-level size and/or accuracy of image calibration, according to size measurements on remaining of the multiple concentric circles.

20. The apparatus according to claim 16, wherein the first image is an image calibrated based at least in part on one or more distortion correction parameters, and wherein the one or more distortion correction parameters are determined by performing a training process based on chessboard segmentation.

21. The apparatus according to claim 20, wherein the training process based on the chessboard segmentation has chessboard images as input data and corresponding mask images as output data, and wherein the chessboard segmentation extracts chessboard parts from the chessboard images by using the corresponding mask images.
